(19) United States
(12) Patent Application Publication
(10) Pub. No.: US 2026/0214106 A1
(43) Pub. Date: Jul. 23, 2026

(54) ANOMALY DETECTION USING ACCUMULATED DATA USAGE COMPARED TO PROJECTED DATA USAGE IN A CLOUD COMPUTING ENVIRONMENT

(71) Applicant: Microsoft Technology Licensing, LLC, Redmond, WA (US)

(72) Inventors: Prabhakaran SETHURAMAN, Redmond, WA (US); Srishty SAHA, Redmond, WA (US); Naveen Joel ISRAEL, Maple Valley, WA (US); Bharat Kumar GANGAVARAPU, Bothell, WA (US)

(21) Appl. No.: 19/027,745

(22) Filed: Jan. 17, 2025

(51) Int. Cl. H04L 9/40; H04L 41/16

(52) U.S. Cl. CPC H04L 63/1425; H04L 41/16; H04L 63/0853

(57) ABSTRACT

A method for detecting an anomaly in resource utilization observed within a cloud computing platform includes observing an actual resource utilization for a customer of the cloud computing platform; determining a historical utilization distribution for the customer that defines values of a resource utilization metric across repeated instances of a time interval and sub-intervals therein; identifying a temporal location of an anomaly detection period within the time interval; filtering the historical utilization distribution to construct a distribution of relevant values of the resource utilization metric; and computing, based on the distribution of relevant values, a resource utilization projection for the customer. An anomaly risk metric in calculated and fit to an anomaly classification to determine the presence of a data usage anomaly. The data usage anomaly is confirmed the using a language model trained on prior data usage anomalies over prior time intervals tagged with actual unauthorized access.

### BACKGROUND

For cloud customers who utilize cloud platforms to conduct business operations, unauthorized account access poses a significant financial and operational risk. If, for example, a fraudster gains unauthorized access to the account of a cloud customer and utilizes large quantities of data storage and/or processing resources that the customer subscribes to use, the cloud customer may be expected to pay for the fraudster's resource utilization or/or be subject to operational disruptions such as delayed processing that results when the unauthorized party is consuming much of the customer's available resource quota.

To help protect cloud customers from instances of unauthorized access and also combat the larger issue of unnecessary resource consumption, cloud resource providers are beginning to adopt various automated tools that help detect and flag resource consumption “anomalies”—e.g., instances of resource consumption that appear atypical of the end user. These tools can automatically detect usage anomalies caused by instances of unauthorized account access as well as system malfunctions, such as processes that hang and unnecessarily tie up resources. Successful detection of these types of usage anomalies can lead to swift remedial actions, such as account lockouts and investigations that resolve underlying causes of wasteful resource consumption.

Existing anomaly detection tools are not especially effective at projecting the unique patterns in resource usage that may be observed across diverse customers and across different time intervals. Consequently, these presently existing anomaly detection tools tend to produce large numbers of false positives and/or false negatives. The increasing complexity of cloud computing infrastructures and the need for consistently secure data processing necessitate a robust and dynamic anomaly detection model to evaluate and allocate compute resources effectively.

### SUMMARY

According to one implementation, the presently disclosed technology includes a method comprising: observing past data usage for a customer within time increments of multiple instances of a time interval; identifying a repeating pattern of data usage within the time increments of the time intervals; based on the past data usage and identified pattern, projecting quantities of data usage for each time increment in a future instance of the time interval; determining, based on the projected quantities of data usage for each time increment in the future instance of the time interval, a projected quantity of data that is expected to be consumed by the customer during a sub-interval within the future instance of the time interval; monitoring actual data usage within time increments of the future instance of the time interval; at the conclusion of the sub-interval, comparing accumulated data usage by the customer with the projected quantity of data usage by the customer; calculating an anomaly risk metric using the accumulated data usage compared with the projected quantity of data usage by the customer; fitting the anomaly risk metric to an anomaly classification to determine the presence of a data usage anomaly; and confirming the data usage anomaly using a language model trained on prior data usage anomalies over prior time intervals tagged with actual unauthorized access.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example logic flow diagram for computing an anomaly risk metric for assessing provider confidence in provisioning cloud compute resources for a requesting customer.

FIG. 2 illustrates an example cloud platform including an anomaly detection tool implementing the disclosed technology.

FIG. 3 illustrates an example system including a cloud computing platform that implements security provisions in response to detected anomalies informed by an anomaly risk metric generated by an anomaly detection tool implementing the herein-disclosed technology.

FIG. 4 illustrates example operations for dynamically detecting resource usage anomalies in cloud computing environments.

FIG. 5 illustrates an example computing device for use in implementing the described technology.

### DETAILED DESCRIPTION

This herein-disclosed technology provides an anomaly detection tool used to evaluate the legitimacy of compute quota requests in a cloud environment and detect potential anomalies that yield unauthorized access and/or data consumption. The anomaly detection tool may leverage an anomaly predictor that uses past customer data consumption patterns to project future data usage, particularly using unique time intervals and sub-intervals to identify patterns and make projections based on those patterns.

The anomaly detection tool that provides high detection accuracy for resource consumption anomalies while also reducing the number of false detections reported as compared to presently existing anomaly detection tools employed for similar purposes. As noted above, presently existing anomaly detection tools tend to be over-sensitive (generating false positives) or under-sensitive (failing to flag actual anomalies) when used to detect resource consumption anomalies. One reason for this is that these tools tend to employ traditional statistical approaches such as standard deviation, variance measures, and regression methods that fail to capture the nuances of customer-specific usage patterns, particularly usage patterns that repeat within pre-determined time intervals, such as months, weeks, or days.

Notably, different types of cloud platform customers may offer different types of web-based services that are characterized by different, industry-specific (or customer-specific) compute usage trends. For example, an online retailer may use cloud resources to process greater numbers of sales orders during the months of November and December due to holiday shopping as compared to other months withing a calendar year. For further example, an online payroll provider may use cloud resources to execute payroll-related processes on the same day or series of days each month. Across longer periods of time, these types of historical resource usage patterns are also subject to changes that are difficult to project. For example, compute resource utilization patterns related to online holiday shopping may be lower in years characterized by economic recession or depression than in other years. Likewise, different enterprises may increase or decrease their cloud resource utilization at dramatically different rates due to industry-specific trends in supply and demand, capital influx, and more.

Statistical approaches employed by currently existing anomaly detection tools (e.g., fraud detection systems) tend to rely on thresholds that classify statistical outliers without any mechanism to adapt the detection thresholds to account for long-term, customer-specific usage trends that may be temporally relevant to pre-determined time intervals being analyzed for anomalous activity. While some of these tools do rely on customer-specific data to set detection thresholds, the detection thresholds are typically calculated based on historical data and fixed thereafter (e.g., until the tool is reconfigured based on newer history data). Consequently, these existing tools are slow to adapt detection thresholds to account for short-term trends, leading to high numbers of false positives and negatives.

The herein-disclosed anomaly detection system addresses the above-noted shortcomings, in part, by tracking customer's cumulative data consumption for each time increment (e.g., days) within a time interval (e.g., a month) and identifying sub-intervals within the time intervals (e.g., phases, such as weeks), where the customer's data consumption is expected to be distinct from other sub-intervals within the time interval. This historical consumption data is used to project the customer's future cumulative data consumption over future time intervals and sub-intervals and allow for identifying disparities that could be anomalies.

Using a customer's cumulative data consumption within time sub-intervals, tracked against a time interval and comparing this to the customer's average historical data consumption within the same time sub-intervals, tracked against the same time interval leads to more accurate anomaly detection.

Further, the customer's average historical data consumption can be a rolling average (e.g., the last 6-months if the time interval is a month) or an average based on the customer's total available historical dataset. Using a rolling average automatically discards older historical data that may not be relevant. Using an average based on the customer's total available historical dataset de-leverages short-term trends (e.g., pertaining to other seasons) in the customer's data usage. Either approach may be used based on the customer's expected historical data usage behavior.

Assume, for example, that a large dataset includes values of a resource utilization metric quantifying the resource usage of a cloud customer each day over a time span of multiple years. From this large dataset, it is possible to identify time intervals (e.g., months) and sub-intervals (e.g., weeks) within the large dataset where repeating patterns may be discerned. For example, trends that repeat cyclically at a particular time of month may be best analyzed and understood by using a subset of the larger dataset that corresponds to a particular time of month. As a further example of this, a projection for the first 10 days of October can be generated using data corresponding to first 10 days of January, February, March . . . , etc. Alternatively, trends that repeat yearly, such as in the same month every year, may be best analyzed by using a subset of the larger dataset that corresponds to the particular month of year. For example, a projection for the month of September might be generated using data corresponding to the month of September for the past ten previous years.

By identifying and utilizing repeating patterns identified within sub-intervals of a time interval to make future data usage projections, the disclosed anomaly detector is able to make more accurate projections of customer-specific usage and, consequently, provide more accurate detection of usage anomalies. In addition to determining and utilizing repeating data usage patterns to define detection thresholds, some implementations of the disclosed technology implement logic that provides for adaptively varying anomaly detection thresholds based on customer feedback pertaining to the accuracy of anomalies detected. If, for example, a customer provides feedback indicating that the anomaly detection tool is identifying large numbers of false positive detections, the anomaly detection logic within the tool may automatically increase the value of a customer-specific parameter used to project usage. This feedback-based dynamic variability in customer-specific anomaly detection thresholds allows the anomaly detector to accurately detect anomalies within complex usage patterns of individual users that evolve over time.

The anomaly detection tool may also leverage a fraud predictor that is used to assess a customer's susceptibility to fraudulent transactions using available credit and banking data on the customer and a Multi-Factor Authentication (MFA) modifier that is used to gauge the Information Technology (IT) security posture of a customer. In some implementations, the customer may pre-authorize access to their credit and banking data to the anomaly detection tool to allow the fraud predictor to perform its functions. In other implementations, the customer's credit and banking data is already accessible to the anomaly detection tool due to a pre-existing creditor/debtor relationship between the cloud customer and the cloud resource provider. The anomaly detection tool uses the anomaly predictor, fraud predictor, and the MFA modifier to generate an anomaly risk metric for a customer for each of the customer's compute quota requests. The anomaly risk metric is a running calculation that is used to determine whether or not to approve a customer's compute quota request each time such a request is made.

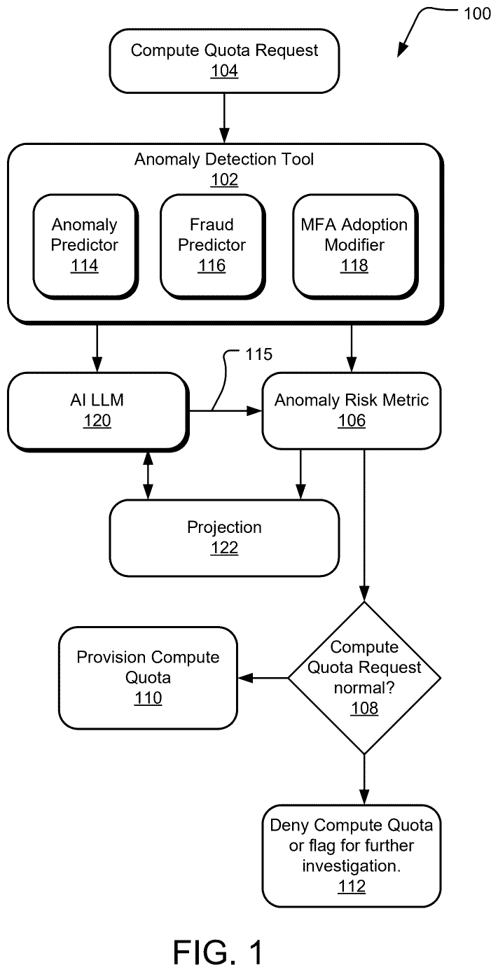

FIG. 1 illustrates an example logic flow diagram 100 for computing an anomaly risk metric 106 for assessing provider confidence in provisioning cloud resources for a requesting customer. In the depicted logic flow diagram 100, the customer issues a compute quota request 104 to the provider. This may be done manually in advance of the customer's data usage or automatically in response to the customer's attempted usage of cloud computing data. The compute quota request 104 is issued every instance of a time increment, which in many examples provided herein is one day. Other implementations may utilize shorter time increments (e.g., hours or minutes) or longer time increments (e.g., weeks or months).

The compute quota request 104 is fed into the anomaly detection tool 102, which is used to generate the anomaly risk metric 106. Operation 108 uses the anomaly risk metric 106 to make a determination whether the compute quota request 104 is consistent with the customer's data usage history and projected future data usage, suggesting that the compute quota request 104 is normal and should be provisioned by the provider. If the compute quota request 104 projects as normal, a compute quota approval instruction 110 is generated, which may allow for the compute quota request 104 to be automatically approved. If the decision operation 108 projects that the compute quota request 104 is anomalous, the compute quota request 104 may be denied or flagged for further investigation prior to granting the compute quota request 104, per operation 112.

The anomaly detection tool 102 utilizes an anomaly predictor 114, a fraud predictor 116, and a multi-factor authentication (MFA) adoption modifier 118 to generate the anomaly risk metric 106. The anomaly predictor 114 projects a customer's future usage velocity values based on past customer data, in order to accurately detect anomalies in cloud computing resource usage. In some example implementations, a customer-specific percentile algorithm calculates daily thresholds for customers based on historical usage patterns. The anomaly predictor 114 calculates a velocity score for quota allocations as and when customers request additional capacity or quota.

The fraud predictor 116 calculates fraud risk using data sourced from banking or credit institutions that provide services to customers. This may include transaction data, compliance scores, and fraud incident data. The calculated fraud risk assesses the customer's overall susceptibility to fraud, which may be correlated with the customer's susceptibility to anomalous consumption of cloud computing resources. The data sourced from banking or credit institutions may be highly confidential, and thus may be processed in a secure and isolated environment, ensuring data protection from unauthorized access even while being processed.

The MFA adoption modifier 118 is used to enhance the accuracy of the anomaly and fraud projections provided by the anomaly predictor 114 and the fraud predictor 116, respectively, by providing a more comprehensive view of a customer's data security measures. Customers with higher MFA adoption rates and more secure MFA types receive a lower modifier, while Customers with lower MFA adoption rates and less secure MFA types receive a higher modifier. The MFA adoption modifier 118 is a composite value that takes into account whether MFA is enabled, the type of MFA used, and the MFA adoption rate at the customer.

An example formula for determining the anomaly risk metric 106 is:

$$Anomaly Risk Metric = AVG [ \{ Anomaly Predictor Score \} * ( 1 - \{ MFA Adjustment Modifier \} , \{ Fraud Predictor Score \} * ( 1 - \{ MFA Adjustment Modifier \} ) ]$$

Where the MFA adoption modifier 118 is determined by:

$$MFA Adjustment Modifier = \{ MFA Enabled \} * \{ MFA Type Weight \} * \{ MFA Adoption Rate \}$$

The anomaly detection tool 102 provides a comprehensive and dynamic assessment of cloud computing resource usage and risk, ultimately improving the accuracy of compute quota allocation in cloud environments. Specifically, using the anomaly predictor 114 to calculate a projected percentile value of cumulative data consumption for a given date and calculate a rolling percentile value for each subsequent date for each customer allows for an improved projection of anomalous compute quota requests. Combining the anomaly projection with the fraud projection provided by the fraud predictor 116 allows the resource provisioner to better understand customer-specific risk of fraud, which is suggestive of anomalous compute quota requests being fraudulent access that should be denied. Combining these anomaly and fraud projections with a modifier reflecting the customer's adoption of MFA as a fraud-prevention technique using the MFA adoption modifier 118 tunes the risk of anomalies being fraudulent and thereby tunes the resulting anomaly risk metric to the risk of actual fraudulent access.

A feedback mechanism, illustrated as arrow 115, may be provided to monitor and update the anomaly risk metric 106, perhaps using an artificial intelligence (AI) enabled language model 120. The model 120 is trained on a dataset that includes risk scores computed for previously received quota increase requests and labels indicating whether each previously-computed risk score corresponded to a legitimate or fraudulent quota increase request. Based on this training dataset, the language model is able to generate a projection 122 of whether or not the compute quota request 104 is a fraudulent access request (e.g., the anomaly indicated fraudulent behavior (positive), or the anomaly does not indicate fraudulent behavior (negative)).

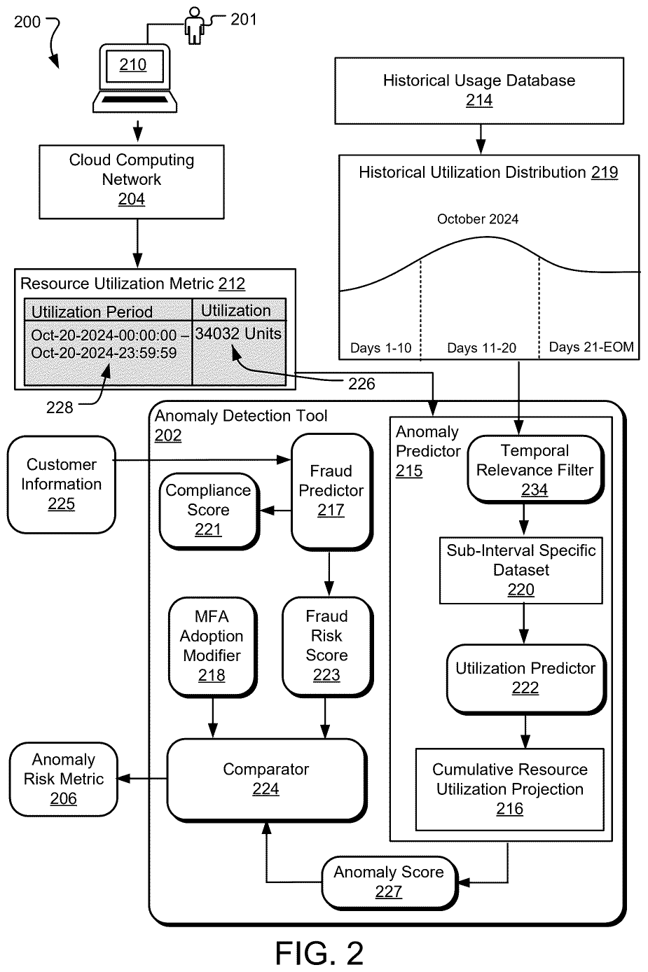

The projection 122 may further be used to confirm detection of a potential data usage anomaly when fitting the anomaly risk metric 106 to an anomaly classification (see e.g., FIG. 2 and detailed description below) by modifying the fit to best match the prior instances of actual confirmed unauthorized access. The AI enabled language model 120 may utilize machine learning techniques (e.g., support vector regressor (SVR), decision tree (DT), and k-nearest neighbors (k-NN)) to modify the calculation of the anomaly risk metric 106 (e.g., by modifying weightings of input variables, such as an anomaly score 227, fraud risk score 223, and/or MFA adoption modifier 218 as provided in FIG. 2 and described in detail below) to iteratively increase the likelihood that the projection 122 (e.g., a positive/negative projection) matches previously received quota increase requests and labels that confirm prior positive/negative projections. This iteration can improve the accuracy of the anomaly risk metric 106 over time and thus improve the accuracy of the projection 122 over time as well.

An example technical benefit of the iterative modification of the anomaly risk metric 106, and thus the accuracy of the projection 122, is fewer false positive indications allows for future compute quote requests to be approved without further scrutiny that would otherwise slow the future compute quote requests down. Another example technical benefit of the iterative modification of the anomaly risk metric 106, and thus the accuracy of the projection 122, is fewer false negative indications prevents fraudulent future compute quote requests from being approved, conserving compute resources for legitimate customer uses.

As used herein, the term “language model” refers to a model that is trained to interpret textual inputs and generate textual outputs. Textual inputs and outputs consist of written words, characters, symbols, and spaces that represent language, ideas, or concepts. Per the above definition, the term “language model” encompasses natural language processing (NLP) models as well as models that process other types of textual inputs, including text-based code and textual characters. Additionally, “language model” encompasses certain multimodal models that can receive prompts that include text, image, audio, and/or video data and that may generate outputs of multiple types that are not necessarily the same as the input type. Example types of language models include transformer-based models such as generative pre-trained transformer (GPT) models, Open Pretrained Transformer (OPT) models, and Bidirectional Encoder Representations from Transformers (BERT) models, as well as Bioscience Large Open-science Open-access Multilingual (BLOOM) models, seq2seq models, long short-term memory (LSTM) network, and recurrent neural networks (RNNs). Examples of publicly available multimodal language models include the Mistral AI model and the large language model Meta AI (LLaMa) model.

FIG. 2 illustrates an example cloud platform 200 including an anomaly detection tool 202 that projects resource usage within a cloud computing network 204 that occurs on behalf of a cloud customer, such as single individual or entity, with access to an account of the cloud platform 200. The anomaly detection tool 202 uses historical usage data to project usages of individual customers, monitors observed (actual) usages and generates an anomaly metric that relates to the degree in which a compute quota request is anomalous.

The cloud platform 200 is a web-based platform that makes hardware resources (e.g., servers, cloud storage, processing units) available to cloud customers, such as in the form of virtual networks configured on behalf of cloud customers, cloud-based data storage accounts, or processing units owned by the cloud provider and configured to execute web-based service(s) of the cloud provider on behalf of various different cloud customers (e.g., web-based pools of models in a model-as-a-service platform).

In one implementation, the cloud computing network 204 represents a single virtual network configured on behalf of a cloud customer to perform storage and processing operations of the cloud customer. In this case, the cloud-based computing network 204 includes one or more virtual machines (VMs) instantiated on physical servers that reside within data center(s) operated by the cloud platform 200. In another implementation, the cloud computing network 204 includes cloud-based servers configured to execute instances of a web-based service on behalf of cloud customers. For example, the cloud computing network 204 includes instances of one or more machine learning models instantiated on behalf of different customers within different model pools that are dynamically allocated processing resources (e.g., graphics processing units (GPUs)) from a shared resource pool.

Each cloud customer (e.g., a cloud customer 201) of the cloud platform 200 platform uses a customer machine 210 to interact with the cloud computing network 204, such as via a web-based control panel of the cloud platform 200. During ongoing normal use, the cloud platform 200 tracks the quantity of computing resources used per unit time by the cloud customer 201. In one implementation, various processing devices (e.g., servers) within the cloud computing network 204 are configured to determine and periodically report values for a resource utilization metric 212 to a centralized entity of the cloud platform 200. The centralized entity, in turn, provides the reported usage values to the anomaly detection tool 202 and also stores the values in a historical usage database 214.

Each value of the resource utilization metric 212 describes a quantity of computing resources consumed by the cloud customer 201 during a corresponding utilization period 228, here illustrated as one day. The phrase “consumed by the cloud customer” refers to any act or configuration performed by or on behalf of the cloud customer 201 that renders the corresponding resources unavailable for use by other cloud customers during the utilization period 228. For example, a quantity of memory is said to be consumed by the cloud customer 201 when the cloud customer 201 initiates a process that reserves the quantity of memory for a period of time, even if the process does not ultimately utilize that memory.

Units of resource utilization may vary from one implementation to another based, in part, on the nature of services provided by the cloud platform 200. Example units of the resource utilization metric 212 include memory utilization per unit time, storage utilization per unit time, token utilization per unit time (e.g., where “token” refers to the smallest processing unit of a language model), or any other resource unit type defined per unit time.

The historical usage database 214 stores values of the resource utilization metric 212 specific to each cloud customer across a time period, such as multiple months or years. Historical utilization distribution 219 defines values of the resource utilization metric 212 for each of multiple fixed time increments across repeated instances of a fixed-length interval. In the example of FIG. 2, the historical utilization distribution 219 defines a utilization value for the resource utilization metric 212 for each day across repeated instances of a month (e.g., all months within one or multiple years). The month is further divided into 10-day sub-intervals (e.g., 1-10 days, 11-20 days, and 21—end-of-month (EOM) phases), the end of each being a point at which the customer's historical data usage is to be compared to customer's current data usage in calculating an anomaly risk metric 206 for the customer 201. The historical usage database 214 may be operated by a provider of the cloud platform 200 or a separate 3^{rd} party.

The anomaly detection tool 202 incorporates an anomaly predictor 215, a fraud predictor 217, and an MFA adoption modifier 218 to calculate the anomaly risk metric 206. The anomaly predictor 215 utilizes data stored in the historical usage database 214 to generate usage projections (e.g., a cumulative resource utilization projection 216) for individual cloud customers and particular sub-intervals of time. Each cumulative resource utilization projection 216 generated by the anomaly detection tool 202 estimates a value of the resource utilization metric 212 that is for a corresponding sub-interval of time and a particular cloud customer of the cloud platform 200.

The anomaly detection tool 202 compares the cumulative resource utilization projection 216 for the cloud customer to a corresponding observed value 226 (e.g., an actual value) of the resource utilization metric 212 for the cloud customer 201 and, generates an anomaly risk metric that captures the likelihood that the customer is experiencing anomalous resource utilization within a current sub-period.

As an initial step in generating the cumulative resource utilization projection 216 for the cloud customer 201, the anomaly detection tool 202 accesses the historical usage database 214 to determine the historical utilization distribution 219 that is applicable to the cloud customer 201. In one implementation, the historical utilization distribution 219 for a cloud customer consists entirely or primarily of historical usage data that is specific to the cloud customer 201, such as historical values of the resource utilization metrics 212 reported by virtual machines configured on behalf of the cloud customer or platform agents that track resource usage specific to the cloud customer 201.

In scenarios where it is determined that the historical usage database 214 stores less than a predefined threshold quantity of the historical usage data for the cloud customer 201 (e.g., there is insufficient history data to make a projection), the anomaly detection tool 202 may, in some implementations, determine the historical utilization distribution 219 for the cloud customer 201 by aggregating together historical usage data collected for a group of cloud customers identified as sharing one or more characteristics with the cloud customer 201. For example, the determined historical utilization distribution 219 is comprised of data collected for a group of cloud customers that all provide goods or services from the same or similar industry as the cloud customer that subscribe to the same subscription tier of service offered by the cloud platform 200, and/or that are associated with (e.g., conduct business operations within) a same geographical location as the cloud customer.

After determining the historical utilization distribution 219 applicable to the cloud customer, the anomaly detection tool 202 uses relevant predetermined time sub-intervals within time intervals, all of which is encompassed within the data of the historical utilization distribution 219. This time sub-interval is used to construct a dataset used to make a usage projection for each future sub-interval. This time sub-interval is a fixed-length interval of time that is repeated multiple times within the time interval and reflects a usage pattern for the customer 201 within each time interval. The length of the time sub-interval may vary in different implementations; however, the time sub-interval is larger than the most granular time dimension available for the resource utilization metric (e.g., a usage quantity per day or per hour).

In some implementations, the anomaly detection tool 202 is configured to recognize and provide usage projections based on a single (predefined and fixed) definition of the time sub-interval. For example, the time sub-interval is a 10-day cycle, three of which are within each month of each year. This definition of the time sub-interval allows the cumulative resource utilization projection 216 to be generated for each day of a month based on cumulative and averaged trend data pertaining to the relevant time sub-interval within which each day resides, as generally represented in the historical utilization distribution 219.

For example, the cumulative resource utilization projection 216 is generated for the day of Oct. 20, 2024, based actual resource utilization by the customer during the month of Oct. 2024 prior to Oct. 20, 2024; adding a projection of data consumption by the customer on Oct. 20, 2024 based on average prior daily resource utilization during the relevant time sub-interval (Days 11-20) of prior months (repeating time intervals). This gives an accurate cumulative resource utilization projection for Oct. 20, 2024, taking into account repeatable patterns in resource utilization by the customer specific to sub-intervals (approximately 10-day periods) within the relevant time interview (1-month).

The average prior daily resource utilization during the relevant time sub-intervals of prior months is referred to herein as a sub-interval specific dataset 220 that includes actual resource utilization values for Days 11-20 of each month throughout the previous 1-year, or other sampling period. This approach of defining time interval and sub-intervals for identifying and leveraging monthly consumer resource utilization behaviors highly effective at yielding accurate usage projections due, in part, to the fact that many cloud customers utilize cloud resources to execute business processes on an inter-monthly cycle (e.g., payroll, revenue metrics, and more), thus leading to inter-monthly trends in resource usage that can be projected based on sub-interval of the month, if not the day of month.

However, in other implementations, the anomaly detection tool 202 is configured to recognize and provide usage projections based on a different definition for the time interval and sub-intervals and/or configured to select between multiple selectable time interval and sub-intervals (or detection period), such as based on the identity of the cloud customer and/or the time increment of interest. An alternative example of time interval and sub-intervals is weeks (interval) and the weekdays/weekends (sub-intervals) therein. Another alternative example of time interval and sub-intervals is days (interval) and the morning, midday, evening, and night periods (sub-intervals) therein.

Some industries are characterized by unique trends that are not observed across 10-day sub-intervals. For example, some customers may focus their resource utilization during the last week of the month, with the other weeks being relatively similar. Such customers may have a first sub-interval defined as Days 1-25 and a second sub-interval defined as Days 16-EOM. The anomaly detection tool 202 may be configured to utilize customer-specific sub-intervals as the applicable cycle when rendering usage projections for customers that fall outside of the normal interval and sub-interval cycle. Some industries may also include anomalous time intervals or sub-intervals that are disregarded for forming the sub-interval specific dataset 220. For example, in the United States, internet-based sales tend to be very high on “Black Friday” and/or “Cyber Monday,” which refers to the day(s) after the Thanksgiving holiday. Thus, November, or the Day 21-EOM sub-interval within November may be disregarded for forming the sub-interval specific dataset 220 as it is expected to be anomalous.

After determining the applicable time interval and sub-intervals for the cloud customer (which is fixed and pre-defined in at least some implementations), the anomaly detection tool 202 next identifies the temporal location of an anomaly detection period of interest. This temporal location is used as a basis for generating the sub-interval specific dataset 220. The sub-interval specific dataset 220 can be understood as including a subset of the data represented within the historical utilization distribution 219 determined for the cloud customer. More specifically, the sub-interval specific dataset 220 includes values for the resource utilization metric 212 corresponding to the same temporal location within the applicable time interval and sub-interval as the detection period.

The sub-interval specific dataset 220 is generated by a temporal relevance filter 234 that filters the historical utilization distribution 219 to redact all values except for a subset of the values that correspond to the same temporal location within the applicable time interval and sub-interval as the detection period. Assume, for example, that the time interval is “one-month” and the sub-interval is the last approximately ten days of the month as the date of interest is Oct. 24, 2024. In this example, the temporal location of the detection period is the last approximately ten days of each month and the sub-interval specific dataset 220 includes usage values that correspond to the last approximately ten days of all months represented in the historical utilization distribution 219.

Notably, the herein-disclosed usage projection methodology depends upon the recognized time interval being longer than the sub-interval time period spanned by each anomaly detection period of interest. Thus, in implementations where the time interval is defined to be a particular day that repeats once each year (e.g., the day after Thanksgiving, Black Friday), the sub-interval is defined as a time period less than 1-day (e.g., 1-hour), and the anomaly detection tool 202 makes projections for periods of time that are shorter than 24 hours. For example, the anomaly detection tool 202 projects resource usage for sub-interval time frames during the day of Black Friday (e.g., 9 am-noon, noon-3 pm, and 3 pm-9 am) based on hourly data corresponding to Black Friday of previous years.

The sub-interval specific dataset 220 is input to a utilization predictor 222 that uses the sub-interval specific dataset 220 as a basis for algorithmically generating the cumulative resource utilization projection 216 for a time increment (e.g., date) of interest. Example projection methodologies are discussed in greater detail with respect to FIG. 2. In the example shown where the detection period of interest is Oct. 20, the cumulative resource utilization prediction 216 projects a resource consumption for Oct. 20, 2024, added to actual resource consumption that has already been incurred for the prior days of October.

The anomaly predictor 215 compares the cumulative resource utilization projection 216 to the actual observed value 226, including summed prior values for the time interval, of the resource utilization metric 212 reported for the cloud customer by the cloud computing network 204 for the time increment of interest to determine an anomaly score 227. A comparator 224 combines the anomaly score 227 with a fraud risk score 223 output from a fraud predictor 217 and a multi-factor authentication (MFA) modifier 218 to generate the anomaly risk metric 206. The anomaly risk metric 206, is a numerical representation of the degree in which that the customer's cumulative resource utilization is anomalous, if at all, and the risk borne by that determination.

An example implementation for customer 201 where the time interval is 1-month, the time sub-intervals are approximately 10-day periods within a month, and the time increment is 1-day. The historical utilization distribution 219 for customer 201 provides that the usage distribution for Days 1-10 is 30% of customer 201's monthly average usage (3% daily,) which reflects customer 201's initial-period average monthly usage. The usage distribution for Days 11-20 is 40% of customer 201's monthly average usage (4% daily), which reflects customer 201's mid-period average monthly usage. The usage distribution for Days 21-EOM is 30% of customer 201's monthly average usage (approx. 3% daily), which reflects customer 201's end-period average monthly usage. Thus, the cumulative usage distribution for Days 1-10 is 30%, Days 11-20 is 70%, and Days 21-EOM is 100%.

The comparator has pre-set percentile limits on the customer 201's resource utilization, such as 98% for Days 1-10, 99% for Days 11-20, and 94% for Days 21-EOM. These pre-set percentile limits may be adjusted based on provider confidence and preferences in provisioning cloud resources. The usage distribution is multiplied by the percentile limits to generate adjusted thresholds. In the example provide above, the adjusted usage distribution for Days 1-10 is 29.4% (2.94% daily), for Days 11-20 is 39.6% (3.96 daily), and for Days 21-EOM is 28.2% (approx. 2.82% daily).

An anomaly classification is applied to the actual observed resource utilization at least at the end of each approximately 10-day period, or in some implementations, at the end of each 1-day time increment to evaluate customer 201's actual observed cumulative resource utilization for the month against customer 201's projected cumulative resource utilization for the month to identify potential anomalies. An example anomaly classification may include:

Less than the projected cumulative usage: No anomaly detected. Anomaly score 227=0.2.

Less than 10% greater than the projected cumulative usage: Anomaly detected, unauthorized access and/or data consumption possible, trigger reporting. Anomaly score 227=0.3.

Between 11-20% greater than projected cumulative usage: Anomaly detected, unauthorized access and/or data consumption likely, trigger reporting or denial of service. Anomaly score 227=0.4.

21% or more greater than projected cumulative usage: Anomaly detected, unauthorized access and/or data consumption possible very likely, trigger reporting and denial of service. Anomaly score 227=0.5.

In a specific example of the implementation described above, customer 201 has an average monthly consumption of cloud compute resources of 200,000 resource units. customer 201 further has an actual observed resource utilization of 124,000 units as of Oct. 26, 2024. Customer 201's projected cumulative usage may be calculated as follows:

$$Projected Cumulative Usage = Average monthly consumption of cloud compute resources * ( [ {1}^{st} 10 - days * 0.0294 ] + [ {2}^{nd} 10 - days * 0.0396 ] + [ 6 of the {3}^{rd} 10 - days * 0.0282 ] ) = 200 \text{,0} 00 * 0.70692 = 141 \text{,3} 84 units$$

As customer 201's actual observed cumulative resource utilization of 124,000 units is less than the 141,384 projected cumulative usage, no anomaly is detected. The anomaly risk metric 206 is 0.2, the lowest option. Customer 201 may further have an actual observed resource utilization of 164,000 units as of Oct. 27, 2024. Customer 201's projected cumulative usage may be calculated as follows:

$$Projected Cumulative Usage = Average monthly consumption of cloud compute resources * ( [ {1}^{st} 10 - days * 0.0294 ] + [ {2}^{nd} 10 - days * 0.0396 ] + [ 7 of the {3}^{rd} 10 - days * 0.0282 ] ) = 200 \text{,0} 00 * 0.70974 = 141 \text{,9} 48 units$$

As customer 201's actual observed cumulative resource utilization of 164,000 units is approximately 15% greater than the 141,948 projected cumulative usage, an anomaly is detected, suggesting unauthorized access and/or data consumption is likely. The anomaly risk metric 206 is 0.4, a generally high option that is designed to trigger reporting or denial of service. The reporting may be to customer 201 and/or the cloud resource provider and may trigger further follow-up. The denial of service may apply immediately for the next requested provisioning of computing resources, perhaps for the following time increment (e.g., day).

The fraud predictor 217 calculates fraud risk using data sourced from banking or credit institutions that provide services to customers (Customer Information 225). This may include transaction data, compliance scores, and fraud incident data. The calculated fraud risk assesses the customer's overall susceptibility to fraud, which may be correlated with the customer's susceptibility to anomalous consumption of cloud computing resources. The data sourced from banking or credit institutions may be highly confidential, and thus may be processed in a secure and isolated environment, ensuring data protection from unauthorized access even while being processed.

Examples of Customer Information 225 that the fraud predictor 217 might access include Transaction Data (e.g., details of individual transactions, such as amounts, dates, merchant information, and payment methods), Account Information (e.g., data related to customer accounts, including account numbers, balances, and transaction history), Personal Identification Information (PII) (e.g., sensitive information such as names, addresses, phone numbers, and Social Security numbers (or equivalents in other countries), Loan and Credit Data (e.g., information regarding loans, credit scores, repayment history, and other related financial products), Fraud Detection Data (e.g., analytics and patterns associated with fraud detection, including transaction anomalies and risk assessments, Compliance and Regulatory Data (e.g., information related to compliance with regulations like AML (Anti-Money Laundering) and KYC (Know Your Customer) data).

As the Customer Information 225 is confidential and may be highly sensitive, the fraud predictor 217 stores and processes the data in a secure enclave, ensuring that it remains confidential and is protected from unauthorized access. Examples of how Customer Information 225 may include Encryption (e.g., data is encrypted both at rest, in transit, and in use), Access Control (e.g., strict access controls ensure that only authorized personnel and applications can access the data), Secure Enclaves (e.g., the data is processed in isolated environments (enclaves) that protect it from other processes on the cloud platform 200, Attestation (e.g., attestation mechanisms to ensure that the code running in the enclave is secure and has not been tampered with), and Compliance Standards (compliance with various industry standards and regulations, ensuring that data handling complies with legal and regulatory requirements).

Banks or other financial institutions involved in a customer's transactions can be the source of tracking that customer's fraud incident data. Specifically, banks maintain records of all transactions processed through their systems. They monitor these transactions for signs of fraudulent activity and can identify incidents of fraud based on patterns, alerts, and customer reports. The banks also often use advanced fraud detection algorithms and tools to flag suspicious transactions and gather data on confirmed fraud incidents. Payment processors also track fraud incidents. They may provide aggregated data to their partners (e.g., banks or merchants) regarding the incidence of fraud in transactions they process. The customers may also have internal fraud reporting mechanisms. They may report incidents to their banks or financial institutions that manage their payment processing. The internal fraud reporting mechanisms may also gather data from internal customer service teams, where fraud related issues are reported by customers. Regulatory Bodies may further compile statistics on fraud incidents across the financial sector and publish reports that banks can use for benchmarking. Any or all of a customer's banks, payment processors, internal reporting mechanisms, and regulatory bodies may be used as a source of the Customer Information 225 that can be used to evaluate the customer's fraud risk. This data can include the number of fraud cases, types of fraud, and related financial impacts, for example.

If direct access to specific customer data is not possible, banks or other financial institutions may provide aggregated fraud incident rates for similar businesses within the same industry, which can be used to inform the risk assessments calculated by the fraud predictor 217. By utilizing the Customer Information 225 effectively, the anomaly detection tool 202 can enhance the accuracy and reliability of the anomaly risk metric 206, helping to identify and mitigate potential risks associated with specific customers.

The fraud predictor 217 utilizes a compliance score 221 that scores a customer's compliance with relevant security and fraud prevention regulations. The compliance score 221 is used by the fraud predictor 217 as an input factor in determining the fraud risk score 223. A classification system is established for each customer that scores the customer's compliance with relevant security and fraud prevention regulations. An example classification system for the compliance score 221 follows.
Score: 90-100→Excellent→The customer is fully compliant with all relevant regulations and standards. The customer has implemented comprehensive compliance measures, has regular audits, and is proactive in managing regulatory requirements.
Score: 80-89→Good→The customer meets most compliance requirements, with only minor issues or gaps identified. Most policies and procedures are in place, with some minor adjustments needed to align fully with all regulations.

Score: 70-79→Fair→The customer shows a moderate level of compliance but has notable gaps that need addressing. Some key compliance areas are lacking, and the organization should work to enhance controls and training.
Score: 60-69→Needs improvement→The customer has several compliance issues and risks that require immediate attention. Several compliance gaps are evident, and the organization is at risk of regulatory scrutiny if not addressed promptly.
Score: 50-59→Poor→The customer is significantly non-compliant, posing a high risk of regulatory penalties. The customer faces significant compliance challenges, requiring immediate remediation efforts to avoid penalties.
Score: Below 50→Critical→The customer is critically non-compliant, with major deficiencies that could lead to severe penalties and operational risks. Major compliance failures are present, potentially leading to severe legal repercussions and a loss of reputation.

An example formula for using the compliance score 221 and other input factors to calculate the fraud risk score 223 for a specific customer follows:

$$Fraud Risk Score = ( Fraud Incidents / Sales Volume ) * ( 100 - Compliance Score ) * ( 1 + Credit Utilization )$$

Using the above formula for the customer 201 with a Sales Volume of $500,000,000, 7 Fraud Incidents in the same period, a Compliance Score of 90, and Credit Utilization of 30%, the fraud risk score 223 is as follows:

$$Fraud Risk Score = ( 7 / 500 \text{,0} 00 \text{,0} 00 ) * ( 100 - 90 ) * ( 1 + 0.3 ) = 1.82 \times {10}^{- 7}$$

A classification system is also established for each customer that equates fraud risk with a fraud risk score 223 that can be used by the comparator 224 in computing the anomaly risk metric 206. An example classification system for the fraud risk score 223 follows.
Score: 0-0.001→Low Risk→The customer exhibits minimal risk. They have a strong compliance record and low fraud incidents.
Score: 0.001-1.01→Moderate Risk→The customer shows some risk factors. While generally compliant, there are occasional fraud incidents or compliance issues.
Score: 0.01-0.1→High Risk→The customer has significant risk factors. They may have a history of fraud incidents, higher credit utilization, or compliance gaps.
Score: 0.1-0.5→Very High Risk→The customer poses a serious risk due to frequent fraud incidents, poor compliance scores, and high credit utilization.
Score: Above 0.5→Critical Risk→The customer is critically non-compliant or has major fraud incidents. Immediate action is required to mitigate risks.

Using the classification system, the customer 201 exhibits low risk.

To enhance the accuracy and reliability of the anomaly risk metric 206, the Multi-Factor Authentication (MFA) adoption modifier 218 is used as a further variable. MFA is a security measure that requires users to provide two or more verification factors to gain access to a resource, significantly reducing the risk of unauthorized access. By considering whether a customer has implemented MFA, the comparator 224 can better evaluate the customer's security posture.

The MFA adoption modifier 218 is calculated by first collecting data on MFA usage from customers. This includes whether MFA is enabled, the type of MFA used (e.g., SMS, app-based, hardware tokens), and the percentage of users within the organization that are using MFA. The collected data is incorporated into a scoring system for the adoption modifier 218, including variables such as:
MFA Enabled: A binary variable indicating whether MFA is enabled (1) or not (0).
MFA Adoption Rate: The percentage of users within the organization using MFA.
MFA Type: Categorical variable indicating the type of MFA used (e.g., SMS, app-based, hardware tokens).

The adoption modifier 218 is calculated by incorporating these MFA-related factors into one or both of the fraud risk score 223 and the anomaly score 227. Customers with higher MFA adoption rates and more secure MFA types (e.g., hardware tokens) should receive lower risk scores, reflecting their stronger security posture.

The adjusted risk score (either the fraud risk score 223 and/or anomaly score 227) will take into account the original risk score and apply adjustments based on whether MFA is enabled, the type of MFA, and the MFA adoption rate. An example formula for an adjusted risk score that incorporates MFA adoption follows.

$$\{ Adjusted Risk Score \} = \{ Original Risk Score \} * ( 1 - \{ MFA Adjustment Factor \} )$$

$$\{ MFA Adjustment Factor \} = \{ MFA Enabled \} * \{ MFA Type Weight \} * \{ MFA Adoption Rate \}$$

The MFA Adjustment Factor may be determined by the following components:
MFA Enabled: A binary variable indicating whether MFA is enabled (1) or not (0).
MFA Type: Different types of MFA have varying levels of security. Assign a weight to each type: Hardware Token: 0.3; App-Based: 0.2; and SMS: 0.1.
MFA Adoption Rate: The percentage of users within the organization using MFA. This can be scaled to a factor between 0 and 1.

In an example implementation where the customer 201's original risk score (the fraud risk score 223 and/or anomaly score 227) is 0.2 and the customer 201 has MFA enabled (1), utilizes hardware-token based MFA (0.3), and has a 90% adoption rate, the customer 201's MFA adjustment factor is:

$$MFA adjustment factor = 1 * 0.3 * 0.9 = 0.27 .$$

The customer's adjusted risk score is:

$$Adjusted risk score = 0.2 * ( 1 - 0.27 ) = 0.146 .$$

The anomaly score 227 and fraud risk score 223 are combined in a simple or weighted average, one or both adopting the MFA adjustment factor from the adoption modifier 218, to determine the anomaly risk metric 206. The anomaly risk metric 206 is used to determine whether a customer's quota request can be fulfilled as and when a customer raises a request and ensure the request is legitimate and not an Account take over (ATO), Unauthorized party abuse (UPA), or otherwise non-payment fraud.

The anomaly score 227 offers several advantages over traditional methods for compute quota allocation in cloud environments. The anomaly score 227 is dynamic and adaptive by integrating multiple factors such as the anomaly predictor 215, fraud predictor 217, and adoption modifier 218 to provide a comprehensive and dynamic assessment of resource usage and risk. Traditional methods often rely on static thresholds and historical data, which may not accurately reflect current usage patterns.

The anomaly score 227 is focused on anomaly detection by projecting future usage velocity values based on past data. Traditional methods may fall short in accurately detecting anomalies and projecting future usage due to their inability to adapt to dynamic usage patterns. The anomaly score 227 evaluates the riskiness of the customer's transactions as a proxy for the customer's vulnerability to fraud, enhancing the accuracy of compute quota allocation. Traditional methods may not incorporate comprehensive risk assessment factors such as credit scores and banking risk scores, leading to less accurate compute quota allocation. The anomaly score 227 incorporates MFA usage to provide a more comprehensive view of a customer's security measures, reducing the risk of unauthorized access. Traditional methods may not consider advanced security measures like MFA usage, increasing the risk of unauthorized access.

In sum, the anomaly risk metric 206 offers a more comprehensive, dynamic, and accurate approach to compute quota allocation in cloud environments compared to traditional methods and existing algorithms. It integrates multiple risk assessment factors and advanced security measures, enhancing overall performance and cost efficiency.

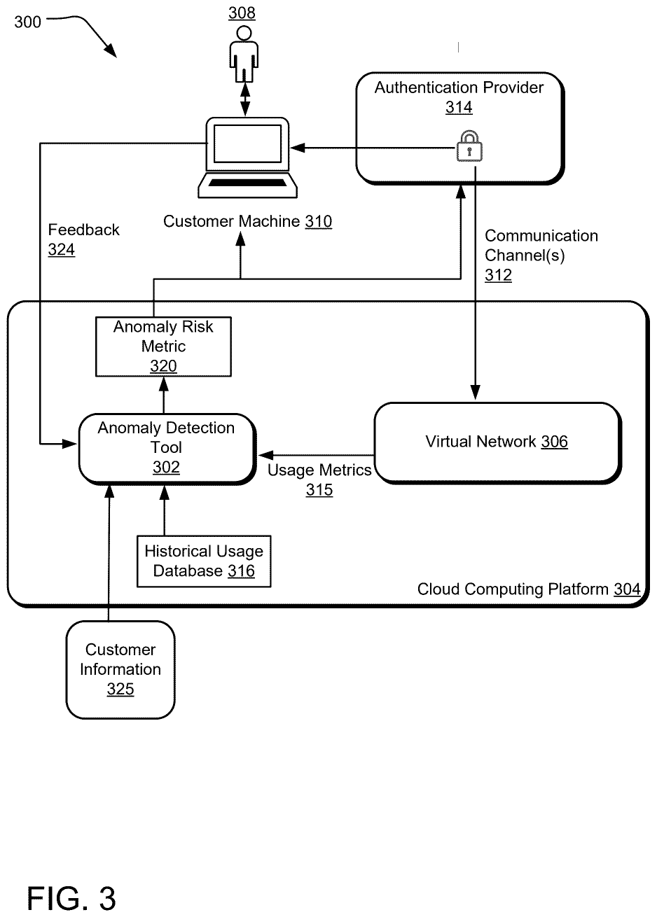

FIG. 3 illustrates an example system 300 including a cloud computing platform 304 that implements security provisions in response to detected anomalies informed by an anomaly risk metric 320 generated by an anomaly detection tool 302 implementing the herein-disclosed technology. In one implementation, the cloud computing platform 304 provides hardware and software resources that allow remote users (cloud customers) to configure virtual networks (e.g., a virtual network 306) to execute workloads on behalf of the respective users. For example, the virtual network 306 is configured on behalf of an end user 308 and includes one or more virtual machines (VMs) that each execute on a data center server operated by a provider of the cloud computing platform 304. The end user 308 interacts with a customer machine 310 to communicate workloads and other information to the virtual network 306 across communication channel(s) 312.

The system 300 further includes an authentication provider 314 that provides authentication services for each different customer account on the cloud computing platform 304. When initializing a new session with the virtual network 306, the customer machine 310 presents security credentials to the authentication provider 314, and the authentication provider 314 conditions access to the virtual network 306 on the authentication of the credentials. In one implementation, the authentication provider 314 implements multi-factor authentication (MFA) that requires the end user 308 to provide two or more forms of access credential to gain access to the VMs within the virtual network 306. For example, the authentication provider 314 authenticates a first set of credentials (e.g., a username/password pair) that the end user 308 presents to the authentication provider 314 via a web-based portal. Subsequent to authenticating the first set of credentials, the authentication provider 314 requests, receives, and authenticates a secondary set of credentials. For example, the secondary set of credentials includes a biometric identifier (e.g., fingerprint, facial or retinal image), or a code that the authentication provider 314 transmits to the end user 308 via email or text message.

The authentication provider 314 may further be tasked with evaluating the anomaly risk metric 320 to determine whether an anomaly is present, and therefore whether additional cloud computing should be provisioned to the end user 308. In such an example implementation, the authentication services performed by the authentication provider 314 include not only the end user 308 initial log-in to the cloud computing platform 304, but review of a subsequent request for provisioning cloud computing resources to the end user 308. In that instance, the authentication provider 314 may provide initial log-in authentication for the end user 308, and then subsequently function as a mechanism tasked with implementing decision operation 108 and if anomalous, deny compute quota or flag for further investigation operation 112 of FIG. 1.

The virtual network 306 is coupled to a control panel (not shown) of the cloud computing platform 304 that collects usage metrics 315 from the virtual network 306. For example, the usage metric quantifies CPU and GPU utilization of the end user 308 in time-based units. Actual observed usages are provided as inputs to the anomaly detection tool 302 and also stored in a historical usage database 316.

The anomaly detection tool 302 uses data in the historical usage database 316 to generate projections of resource usage by the virtual network 306 for rolling time increments, tracked over time intervals and sub-intervals. Projections are generated per a methodology consistent with that disclosed elsewhere herein. The anomaly detection tool 302 compares the usage projection for each detection period to a corresponding actual usage observed within the virtual network 306 (e.g., as indicated by the usage metrics 315) to generate an anomaly score (not shown, see e.g., anomaly score 227 of FIG. 2).

The anomaly detection tool 302 also generates a fraud projection score (not shown, see e.g., fraud risk score 223 of FIG. 2) using Customer Information 325 collected from banking or other financial institutions of the end user 308. The anomaly detection tool 302 further still calculates an MFA adoption modifier (not shown, see e.g., adoption modifier 218 of FIG. 2) as a risk modifier applicable to one or both of the anomaly score and the fraud risk score. The anomaly score and the fraud risk score are combined in a simple of weighted average to generate the anomaly risk metric 320.

In addition to triggering the authentication provider 314 to evaluate the anomaly risk metric 320 to determine whether an anomaly is present, the anomaly risk metric 320 may be conveyed to the customer machine 310. For example, the anomaly risk metric 320 is presented within a control panel accessible through a web-based portal that the end user 308 accesses, using account credentials, to view information pertaining to the customer's account on the cloud computing platform 304. In one implementation, the anomaly risk metric 320 identifies the anomaly detection period as well as the projected and observed resource utilization of the customer during the detection period. The control panel includes interactive UI elements that allow the end user 308 to provide feedback 324 that indicates whether or not the end user 308 believes that the recorded usage was due to unauthorized account access or other suspicious cause that merits further investigation.

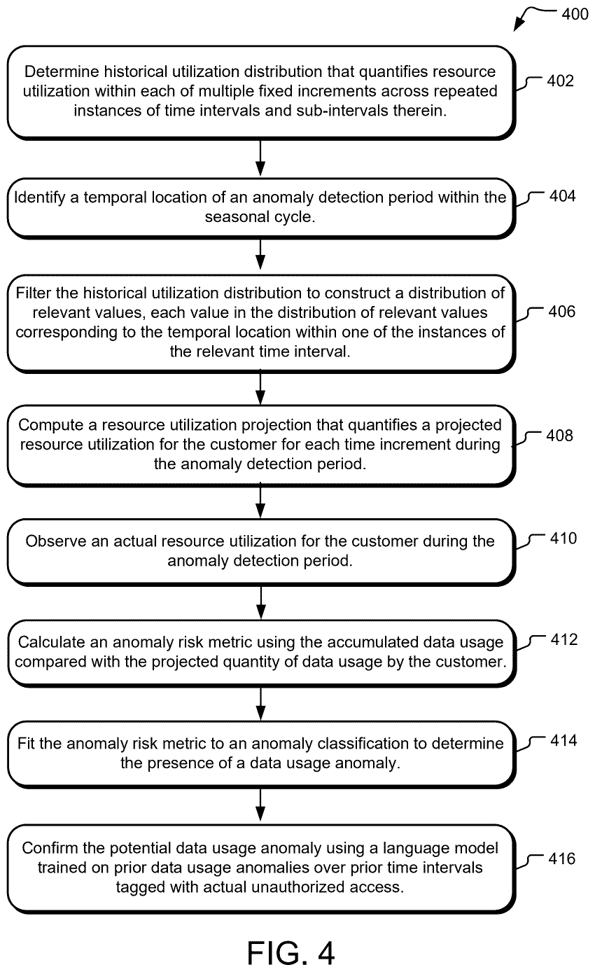

FIG. 4 illustrates example operations 400 for dynamically detecting resource usage anomalies in cloud computing environments. A dataset construction operation 402 determines, for a cloud customer, a historical utilization distribution that includes values that quantify resource utilization within each of multiple fixed increments across repeated instances of time intervals and sub-intervals therein.

An identifying operation 404 identifies a temporal location of an anomaly detection period within the time interval. If, for example, the time interval is defined as a one-month cycle that repeats each month, and the sub-intervals are approximately 10-day periods at beginning, middle, and end of the month, the identifying operation 404 entails identifying the month (e.g., April of 2024) and 10-day period (e.g., the first 10-day period of April 2024) as the detection period.

A filtering operation 406 filters the historical utilization distribution to construct a distribution of time interval and sub-interval relevant values (e.g., a subset of the values within the historical utilization distribution). Each value in the distribution of relevant values corresponds to the temporal location within the time interval. Thus, filtering entails identifying a subset of the fixed time increments within the historical utilization distribution that correspond to the temporal location and preserving the corresponding values while filtering all other values from the historical utilization distribution.

A computation operation 408 uses the distribution of relevant values to generate (compute) a resource utilization projection that quantifies a projected resource utilization for the customer for each time increment during the anomaly detection period. In one implementation, the resource utilization projection is determined based, at least in part, on configurable percentile of the distribution of relevant values during the relevant sub-interval.

An observation operation 410 observes an actual resource utilization for the customer during the anomaly detection period. A calculating operation 412 calculates an anomaly risk metric using the accumulated data usage compared with the projected quantity of data usage by the customer, in some implementations combined with a calculation of fraud risk with an MFA adoption modifier. A fitting operation 414 fits the anomaly risk metric to an anomaly classification to determine the presence of a data usage anomaly.

A confirming operation 416 confirms the potential data usage anomaly using a language model trained on prior data usage anomalies over prior time intervals tagged with actual unauthorized access. Confirmed data usage anomalies may trigger denial of service or denial of cloud resources provisioning requests by the customer. Confirmed data usage anomalies may also generates an anomaly alert to the customer and/or the cloud resources provider.

The logical operations or method steps described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, depending on the computer system's performance requirements. Accordingly, the logical operations making up the implementations described herein are referred to variously as operations, steps, objects, or modules. Furthermore, it should be understood that logical operations may be performed in any order unless explicitly claimed otherwise or a specific order is inherently necessitated by the claim language. The above specification, examples, and data, together with the attached appendices, provide a complete description of the structure and use of exemplary implementations.

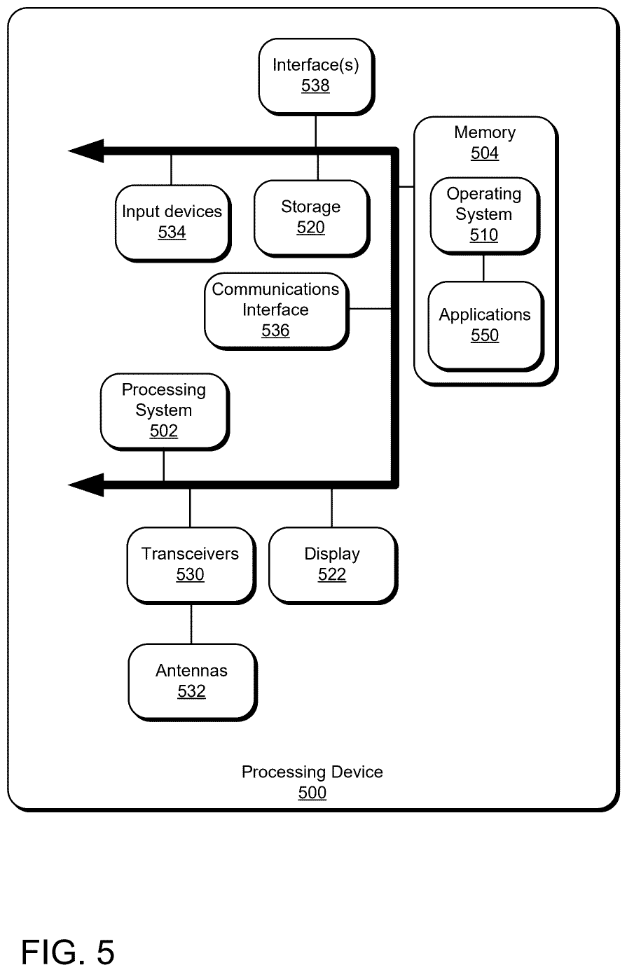

FIG. 5 illustrates an example computing device 500 for use in implementing the described technology. The computing device 500 may be a client computing device (such as a laptop computer, a desktop computer, or a tablet computer), a server/cloud computing device, an Internet-of-Things (IoT), any other type of computing device, or a combination of these options. The computing device 500 includes one or more hardware processor(s) 502 and a memory 504. The memory 504 generally includes both volatile memory (e.g., RAM) and nonvolatile memory (e.g., flash memory), although one or the other type of memory may be omitted. An operating system 510 resides in the memory 504 and is executed by the processor(s) 502. In some implementations, the computing device 500 includes and/or is communicatively coupled to storage 520.

In the example computing device 500, as shown in FIG. 5, one or more software modules, segments, and/or processors, such as applications 550 (e.g., the anomaly detection tool 302) are loaded into the operating system 510 on the memory 504 and/or the storage 520 and executed by the processor(s) 502. The storage 520 may store historical resource utilization data for customers of a cloud platform as well as customer-specific detection parameters used to project customer usage and set detection thresholds.

The computing device 500 may include one or more communication transceivers 530, which may be connected to one or more antenna(s) 532 to provide network connectivity (e.g., mobile phone network, Wi-Fi®, Bluetooth®) to one or more other servers, client devices, IoT devices, and other computing and communications devices. The computing device 500 may further include a communications interface 536 (such as a network adapter or an I/O port, which are types of communication devices) that is used to establish connections over a wide-area network (WAN) or local-area network (LAN). It should be appreciated that the network connections shown are exemplary and that other communications devices and means for establishing a communications link between the computing device 500 and other devices may be used.

The computing device 500 may include one or more input devices 534 such that a user may enter commands and information (e.g., a keyboard, trackpad, or mouse). These and other input devices may be coupled to the server by one or more interfaces 538, such as a serial port interface, parallel port, or universal serial bus (USB). The computing device 500 may further include a display 522, such as a touchscreen display.

The computing device 500 may include a variety of tangible processor-readable storage media and intangible processor-readable communication signals. Tangible processor-readable storage can be embodied by any available media that can be accessed by the computing device 500 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes but is not limited to RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 500. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Implementations described herein include a method comprising: observing past data usage for a customer within time increments of multiple instances of a time interval; identifying a repeating pattern of data usage within the time increments of the time intervals; based on the past data usage and identified pattern, projecting quantities of data usage for each time increment in a future instance of the time interval; determining, based on the projected quantities of data usage for each time increment in the future instance of the time interval, a projected quantity of data that is expected to be consumed by the customer during a sub-interval within the future instance of the time interval; aggregating actual data usage of the customer throughout time increments of the sub-interval to determine an accumulated data usage by the customer for the sub-interval; comparing the accumulated data usage by the customer with the projected quantity of data usage by the customer for the sub-interval; calculating an anomaly risk metric using the accumulated data usage compared with the projected quantity of data usage by the customer; fitting the anomaly risk metric to an anomaly classification to determine the presence of a data usage anomaly; and confirming the data usage anomaly using a language model trained on prior data usage anomalies over prior time intervals tagged with actual unauthorized access.

The past data usage and the repeating pattern of data usage may be specific to the customer.

The time increments may be days, the time interval may be a month, and the sub-interval may be a phase within the month.

Time increments may be days, the time interval may be a week, and the sub-interval may be a phase within the week.

The time increments may be hours, the time interval may be a day, and the sub-interval may be a phase within the day.

The anomaly risk metric may be calculated at an end of each time interval.

Confirming the data usage anomaly may include: executing the language model to determine anomaly risk metrics for prior confirmed disparities over prior time intervals tagged with actual unauthorized access; and comparing the calculated anomaly risk metric for a current time interval with the language model determined anomaly risk metrics based on prior confirmed disparities tagged with actual unauthorized access.

The method may further comprise modifying weightings of factors input to the calculated anomaly risk metric to fit the calculated anomaly risk metric to the language model determined anomaly risk metric.

The method may further comprise calculating an anomaly score related to a degree in which the accumulated data usage exceeds the projected quantity of data usage.

The method may further comprise calculating a fraud risk score related to susceptibility of the customer to fraud.

The method may further comprise calculating a multi-factor authentication (MFA) adoption modifier indicative of the customer's security posture.

The method may further comprise combining the anomaly score, fraud risk score, and MFA adoption modifier into the calculation of the anomaly risk metric.

The method may further comprise denying a customer's compute quota request when the anomaly risk metric is above a threshold.

The method may further comprise approving a customer's compute quota request when the anomaly risk metric is below a threshold.

Implementations described herein include a system comprising: a cloud computing platform that provides processing resources to a cloud customer; and an anomaly detection tool stored in memory and deployed within the cloud computing platform. The anomaly detection tool to: observe past data usage for a customer within time increments of multiple instances of a time interval; identify a repeating pattern of data usage within the time increments of the time intervals; based on the past data usage and identified pattern, project quantities of data usage for each time increment in a future instance of the time interval; determine, based on the projected quantities of data usage for each time increment in the future instance of the time interval, a projected quantity of data that is expected to be consumed by the customer during a sub-interval within the future instance of the time interval; aggregate actual data usage of the customer throughout time increments of the sub-interval to determine an accumulated data usage by the customer for the sub-interval; compare the accumulated data usage by the customer with the projected quantity of data usage by the customer for the sub-interval; calculate an anomaly risk metric using the accumulated data usage compared with the projected quantity of data usage by the customer; fit the anomaly risk metric to an anomaly classification to determine the presence of a data usage anomaly; and confirm the data usage anomaly using a language model trained on prior data usage anomalies over prior time intervals tagged with actual unauthorized access.

Confirming the data usage anomaly may include: executing the language model to determine anomaly risk metrics for prior confirmed disparities over prior time intervals tagged with actual unauthorized access; and comparing the calculated anomaly risk metric for a current time interval with the language model determined anomaly risk metrics based on prior confirmed disparities tagged with actual unauthorized access.

The anomaly detection tool may further: calculate an anomaly score related to a degree in which the accumulated data usage exceeds the projected quantity of data usage; calculate a fraud risk score related to susceptibility of the customer to fraud; calculate a multi-factor authentication (MFA) adoption modifier indicative of the customer's security posture; and combine the anomaly score, fraud risk score, and MFA adoption modifier into the calculation of the anomaly risk metric.

Implementations described herein include one or more tangible processor-readable storage media encoding instructions for executing a process comprising: accessing a database to retrieve historical usage data for a customer of a cloud computing platform, the historical usage data including values of a resource utilization metric quantifying a resource utilization of the customer within each of multiple fixed time increments across repeated instances of a time interval and sub-intervals; identifying a repeating pattern of data usage within time increments of multiple instances of a time interval; based on the historical usage data and the identified pattern, projecting quantities of data usage for each time increment in a future instance of the time interval; determining, based on the projected quantities of data usage for each time increment in the future instance of the time interval, a projected quantity of data that is expected to be consumed by the customer during a sub-interval within the future instance of the time interval; aggregating actual data usage of the customer throughout time increments of the sub-interval to determine an accumulated data usage by the customer for the sub-interval; comparing the accumulated data usage by the customer with the projected quantity of data usage by the customer for the sub-interval; calculating an anomaly risk metric using the accumulated data usage compared with the projected quantity of data usage by the customer; fitting the anomaly risk metric to an anomaly classification to determine a presence of a data usage anomaly; and confirming the data usage anomaly using a language model trained on prior data usage anomalies over prior time intervals tagged with actual unauthorized access.

Confirming the data usage anomaly may include: executing the language model to determine anomaly risk metrics for prior confirmed disparities over prior time intervals tagged with actual unauthorized access; and comparing the calculated anomaly risk metric for a current time interval with the language model determined anomaly risk metrics based on prior confirmed disparities tagged with actual unauthorized access.

The process may further comprise: calculating an anomaly score related to a degree in which the accumulated data usage exceeds the projected quantity of data usage; calculating a fraud risk score related to susceptibility of the customer to fraud; calculating a multi-factor authentication (MFA) adoption modifier indicative of the customer's security posture; and combining the anomaly score, fraud risk score, and MFA adoption modifier into the calculation of the anomaly risk metric.

What is claimed is:

1. A method comprising:
observing past data usage for a customer within time increments of multiple instances of a time interval;
identifying a repeating pattern of data usage within the time increments of the time intervals;
based on the past data usage and identified pattern, projecting quantities of data usage for each time increment in a future time interval;
determining, based on the projected quantities of data usage for each time increment in the future time interval, a projected quantity of data that is expected to be consumed by the customer during a sub-interval within the future time interval;
aggregating actual data usage of the customer throughout time increments of the sub-interval to determine an accumulated data usage by the customer for the sub-interval;
comparing the accumulated data usage by the customer with the projected quantity of data usage by the customer for the sub-interval;
calculating an anomaly risk metric using the accumulated data usage compared with the projected quantity of data usage by the customer;
fitting the anomaly risk metric to an anomaly classification to determine the presence of a data usage anomaly;
confirming the data usage anomaly using a language model trained on prior data usage anomalies over prior time intervals tagged with actual unauthorized access; and
approving a customer's compute quota request when the anomaly risk metric is below a threshold.

2. The method of claim 1, wherein the past data usage and the repeating pattern of data usage is specific to the customer.

3. The method of claim 1, wherein the time increments are days, the time interval is a month, and the sub-interval is a phase within the month.

4. The method of claim 1, wherein the time increments are days, the time interval is a week, and the sub-interval is a phase within the week.

5. The method of claim 1, wherein the time increments are hours, the time interval is a day, and the sub-interval is a phase within the day.

6. The method of claim 1, wherein the anomaly risk metric is calculated at an end of each time interval.

7. The method of claim 1, wherein confirming the data usage anomaly includes:
executing the language model to determine anomaly risk metrics for prior confirmed disparities over prior time intervals tagged with actual unauthorized access; and
comparing the calculated anomaly risk metric for a current time interval with the language model determined anomaly risk metrics based on prior confirmed disparities tagged with actual unauthorized access.

8. The method of claim 7, further comprising:
modifying weightings of factors input to the calculated anomaly risk metric to fit the calculated anomaly risk metric to the language model determined anomaly risk metric.

9. The method of claim 1, further comprising:
calculating an anomaly score related to a degree in which the accumulated data usage exceeds the projected quantity of data usage.

10. The method of claim 9, further comprising:
calculating a fraud risk score related to susceptibility of the customer to fraud.

11. The method of claim 10, further comprising:
calculating a multi-factor authentication (MFA) adoption modifier indicative of the customer's security posture.

12. The method of claim 11, further comprising:
combining the anomaly score, fraud risk score, and MFA adoption modifier into the calculation of the anomaly risk metric.

13. The method of claim 1, further comprising:
denying a customer's compute quota request when the anomaly risk metric is above a threshold.

14. A system comprising:
a cloud computing platform that provides processing resources to a cloud customer; and
an anomaly detection tool stored in memory and deployed within the cloud computing platform to:
observe past data usage for a customer within time increments of multiple instances of a time interval;
identify a repeating pattern of data usage within the time increments of the time intervals;
based on the past data usage and identified pattern, project quantities of data usage for each time increment in a future instance of the time interval;
determine, based on the projected quantities of data usage for each time increment in the future instance of the time interval, a projected quantity of data that is expected to be consumed by the customer during a sub-interval within the future instance of the time interval;
aggregate actual data usage of the customer throughout time increments of the sub-interval to determine an accumulated data usage by the customer for the sub-interval;
compare the accumulated data usage by the customer with the projected quantity of data usage by the customer for the sub-interval;
calculate an anomaly risk metric using the accumulated data usage compared with the projected quantity of data usage by the customer;
fit the anomaly risk metric to an anomaly classification to determine the presence of a data usage anomaly;
confirm the data usage anomaly using a language model trained on prior data usage anomalies over prior time intervals tagged with actual unauthorized access
approve a customer's compute quota request when the anomaly risk metric is below a threshold.

15. The system of claim 14, wherein confirming the data usage anomaly includes:
executing the language model to determine anomaly risk metrics for prior confirmed disparities over prior time intervals tagged with actual unauthorized access; and
comparing the calculated anomaly risk metric for a current time interval with the language model determined anomaly risk metrics based on prior confirmed disparities tagged with actual unauthorized access.

16. The system of claim 14, wherein the anomaly detection tool is further to:
calculate an anomaly score related to a degree in which the accumulated data usage exceeds the projected quantity of data usage;
calculate a fraud risk score related to susceptibility of the customer to fraud;
calculate a multi-factor authentication (MFA) adoption modifier indicative of the customer's security posture; and
combine the anomaly score, fraud risk score, and MFA adoption modifier into the calculation of the anomaly risk metric.

17. The system of claim 14, wherein the anomaly detection tool is further to:
deny a customer's compute quota request when the anomaly risk metric is above a threshold.

18. One or more tangible processor-readable storage media encoding instructions for executing a process comprising:
accessing a database to retrieve historical usage data for a customer of a cloud computing platform, the historical usage data including values of a resource utilization metric quantifying a resource utilization of the customer within each of multiple fixed time increments across repeated instances of a time interval and sub-intervals;
identifying a repeating pattern of data usage within time increments of multiple instances of a time interval;
based on the historical usage data and the identified pattern, projecting quantities of data usage for each time increment in a future instance of the time interval;
determining, based on the projected quantities of data usage for each time increment in the future instance of the time interval, a projected quantity of data that is expected to be consumed by the customer during a sub-interval within the future instance of the time interval;
aggregating actual data usage of the customer throughout time increments of the sub-interval to determine an accumulated data usage by the customer for the sub-interval;
comparing the accumulated data usage by the customer with the projected quantity of data usage by the customer for the sub-interval;
calculating an anomaly risk metric using the accumulated data usage compared with the projected quantity of data usage by the customer;
fitting the anomaly risk metric to an anomaly classification to determine a presence of a data usage anomaly;
confirming the data usage anomaly using a language model trained on prior data usage anomalies over prior time intervals tagged with actual unauthorized access; and
one of approving a customer's compute quota request when the anomaly risk metric is below a threshold and denying the customer's compute quota request when the anomaly risk metric is above the threshold.

19. The tangible processor-readable storage media of claim 18, wherein confirming the data usage anomaly includes:
executing the language model to determine anomaly risk metrics for prior confirmed disparities over prior time intervals tagged with actual unauthorized access; and
comparing the calculated anomaly risk metric for a current time interval with the language model determined anomaly risk metrics based on prior confirmed disparities tagged with actual unauthorized access.

20. The tangible processor-readable storage media of claim 18, wherein the process comprises:
calculating an anomaly score related to a degree in which the accumulated data usage exceeds the projected quantity of data usage;
calculating a fraud risk score related to susceptibility of the customer to fraud;
calculating a multi-factor authentication (MFA) adoption modifier indicative of the customer's security posture; and
combining the anomaly score, fraud risk score, and MFA adoption modifier into the calculation of the anomaly risk metric.
